(19) United States
(12) Patent Application Publication
(10) Pub. No.: US 2014/0149286 A1
(43) Pub. Date: May 29, 2014

(54) Transaction Execution

(71) Applicant: NCR Corporation, Duluth, GA (US)

(72) Inventor: Gordon Forsyth, Scotland (GB)

(73) Assignee: NCR CORPORATION, Duluth, GA (US)

(21) Appl. No.: 13/688,345

(22) Filed: Nov. 29, 2012

(51) Int. Cl. G06Q 20/10

(52) U.S. Cl. CPC G06Q 20/1085
USPC 705/43

(57) ABSTRACT

A method and apparatus are disclosed for storing data. The method includes the steps of, when a transaction executing terminal is in a non-communicative state with respect to a primary authorizing node, storing data associated with at least one transaction carried out at the terminal, and authorized by a further authorizing node, under fault tolerant conditions.

### FIELD OF THE INVENTION

The present invention relates to a method and apparatus for storing data and executing transactions. In particular, but not exclusively, the present invention relates to the storage of data associated with transactions carried out at a terminal which is able to execute transactions under authorization from more than one authorizing node. When a primary authorizing node is out of communication with the terminal, transactions may continue to be performed at the terminal under the authorization of a further authorizing node with data identifying details of the transactions carried out being stored under fault tolerant conditions for future use.

Many different types of terminals are known which are able to execute transactions. Such terminals may be Self-Service Terminals (SSTs) or assisted service terminals. An example of a well-known SST is an Automated Teller Machine (ATM). Such terminals are often networked together for use by members of the public or members of an organization as part of a financial network. The ATMs form nodes or network end points which may be located in bank branches, in building lobbies or other sites spread over a city, county or country. Management of such networks is often complex and costly for those concerned with such matters. Typically dedicated systems are required to collect data such as status information and/or level of consumable information or the like from the terminals and to transmit this data from time to time to a network management center.

A particular problem arises at terminals able to carry out transactions when a failure occurs at that device. For example, data associated with transactions including a time and date of transaction and/or a user party to a transaction and/or a quantity of a consumable associated with the transaction must be stored at the terminal. Typically, such storage occurs on a hard disk. If the hard disk fails or software running on the terminal is corrupted, then key information may be lost. Such key information is referred to as transaction critical data. Even the loss of non-transaction critical data can be problematic and should be avoided if at all possible.

Particular problems can occur when a terminal is able to execute transactions under authorization from multiple authorizing nodes. For example, when a terminal is a terminal in a financial institution that terminal may operate under teller control during office hours when there is a teller present to assist with any financial transactions. In this environment the terminal connects to a branch host (which thus acts as an authorizing node) which instructs the terminal to perform or not perform transactions. The branch host thus acts as a primary authorizing node authorizing execution of transactions. However, out of office hours the terminal may be re-booted and connected to a traditional ATM network. This terminal would not then communicate with the branch host for a period of time. Instead, all transactions are routed from the terminal via the ATM network host node. The ATM host is thus an example of a further authorizing node which instructs the terminal to perform or not perform transactions. In the morning or after the lapse of a pre-determined period of time, the terminal is configured, for example, by staff in a bank branch re-booting the terminal to make it operate as a branch terminal again. This gives rise to the problem that different hosts (branch and ATM network) may have instructed the ATM to dispense cash or carry out one or more transactions. There therefore needs to be a reconciliation between transactions authorized by the ATM host and transactions executed under authorization from a branch host. Such information is necessary to determine an actual amount of cash etc. remaining at the terminal. In the instance of a failure at the terminal information associated with transactions carried out under authorization of the further node may be lost. This makes it impossible or at least very difficult to carry out the reconciliation process.

### SUMMARY OF THE INVENTION

It is an aim of the present invention to at least partly mitigate the above-mentioned problems.

It is an aim of certain embodiments of the present invention to ensure that data associated with transactions carried out at a terminal are stored under fault tolerant conditions so that the data can subsequently be made available for reconciliation and auditing purposes.

It is an aim of certain embodiments of the present invention to provide a transaction execution system including one or more transaction executing terminals, a primary and at least one further authorizing node and a storage mechanism for storing data associated with transactions executed at the terminal in such a way that all data or at least transaction critical data will not be lost and can subsequently be made available.

It is an aim of certain embodiments of the present invention to provide an ATM and/or network of ATMs in which transaction critical data associated with transactions carried out at the ATMs are stored remotely via a network such as the internet or the like under fault tolerant conditions.

According to a first aspect of the present invention there is provided a method of storing data, comprising the steps of:
when a transaction executing terminal is in a non-communicative state with respect to a primary authorizing node, storing data associated with at least one transaction carried out at the terminal, and authorized by a further authorizing node, under fault tolerant conditions.

Aptly, the terminal is an Automated Teller Machine (ATM) and said step of storing data comprises storing at least transaction critical data associated with at least one transaction carried out at the ATM.

Aptly, the step of storing the critical data comprises:
subsequent to, or contemporaneous with, the completion of transaction authorized by the further authorizing node at said ATM, providing the transaction critical data associated with said transaction via a network to a server node, remote from said ATM, comprising a secure storage medium; and
storing the critical data via the secure storage medium.

Aptly, the step of storing the critical data comprises:
during a transaction initiated between the ATM and the further authorizing node, repeatedly communicating critical data associated with the transaction via a network to a server node, remote from said ATM, comprising a secure storage medium; and
storing the critical data via the secure storage medium.

Aptly, the method further comprises the steps of:
performing a plurality of transactions at the ATM whilst the ATM is in said non-communicative state; and
for each transaction storing associated transaction critical data under full tolerant conditions.

Aptly, the method further comprises the steps of:
when the ATM returns to a communicative state with said primary authorizing node, communicating the stored critical data to the ATM; and
subsequently communicating the critical data or data associated with the critical data from the ATM to the primary authorizing node.

Aptly, the method further comprises the steps of:
communicating the stored critical data to the ATM and communicating the critical data or the associated data from the ATM to the primary authorizing node transaction-by-transaction for each said transaction carried out at the ATM whilst the ATM was in the non-communicative state.

Aptly, the step of storing the critical data via the secure storage medium comprises at least one of:
storing the data in a secure storage device of the server node; and/or

storing the data via a duplicator in a first and second data store that each stores a
copy of the critical data; and/or

storing the data as electronic data in a recording store.

Aptly, the step of providing critical data via a network comprises providing the critical data via the internet.

Aptly, the step of providing critical data comprises providing data identifying a user ID and/or a currency amount associated with a dispense or deposit transaction and/or a transaction data and/or a transaction time and/or power fail recovery data.

Aptly, the method comprises storing secure data prohibited according to the Payment Application Data Security Standard (PA-DSS) and associated with a card transaction executed at the terminal, under said fault tolerant conditions.
Aptly, the method stores the secure data so as to protect the data from unauthorized access. Optionally, transmission of the data is encrypted and/or data is stored in an encrypted format.

According to a second aspect of the present invention there is provided a transaction execution system, comprising:
at least one transaction executing terminal comprising a primary authorizing node agent and at least one further authorizing node agent;
a primary authorizing node connectable to the terminal for selectively authorizing transactions at the terminal via the primary authorizing node agent;
at least one further authorizing node connectable to the terminal for selectively authorizing transactions at the terminal via the further authorizing node agent; and
a storage medium for storing data associated with transactions executed at the terminal under fault tolerant conditions.

Aptly, the system is a cash management system, each terminal comprises an Automated Teller Machine (ATM) and the storage medium is remote from the ATM and stores at least transaction critical data associated with at least one transaction carried out at the ATM.

Aptly, the cash management system comprises a remote server node connectable to the ATM via a network and comprising the storage medium.

Aptly, the cash management system further comprises:
the storage medium comprises a first data store and at least one further data store; and
a duplicator that copies incoming critical data and stores corresponding data in each data store.

Aptly, the network comprises the Internet.

According to a third aspect of the present invention there is provided a method of operating a transaction executing terminal comprising the steps of:
storing data associated with operation of the terminal under fault tolerant conditions remotely from the terminal.

Aptly, the method further comprises storing data remotely from the SST under fault tolerant conditions.

Aptly, the method further comprises the steps of:
storing data remotely when a primary transaction node is in a non-communicative state with the SST and a transaction at the SST is authorized via a local authorizing agent.

Aptly, the method further comprises the steps of:
determining if a primary transaction node is in a non-communicative state and a transaction at the SST is authorized locally via local PIN authentication or other such authentication mechanism.

Aptly, the method further comprises the steps of:
determining if a primary transaction node is in a non-communicative state;
initiating an EMV card-type transaction at the SST;
authorizing the transaction via local PIN authorization; and
storing the data associated with the transaction remotely from the SST.

Aptly, the method further comprises storing the data remotely via an NVRAM interface.

Aptly, the method further comprises storing transaction progress data locally at the SST and storing rarely accessed data remotely from the SST.

Aptly, the method further comprises storing electronic journal records remotely from the SST.

Aptly, the method further comprises storing the electronic journal records via an electronic journal interface.

Aptly, the method further comprises the steps of:
storing data remotely when the SST is an SST that supports at least two modes of operation and transactions carried out during each mode of operation are authorized by a respective transaction authorizing node.

Aptly, the method further comprises the steps of:
reporting data stored during a first mode of operation to an authorizing node associated with a new mode of operation when the SST is switched from an old mode of operation to the new mode of operation.

Aptly, the method further comprises the steps of:
storing data remotely when the terminal is a terminal that supports teller assisted transactions and self-service transactions.

Aptly, the method further comprises storing data associated with every transaction performed at the SST.

Aptly, the method further comprises storing only aggregated dispense and/or deposit total associated with transactions performed at the SST.

According to a fourth aspect of the present invention there is provided a server for communicating with a transaction terminal switchable between a self-serve mode and an assisted serve mode, where the server is operable to:
receive information from the transaction terminal when the transaction terminal is operating in assisted serve mode;
store the received information in an entry for that transaction terminal in a data store accessible by the server;
receive information from the transaction terminal when the transaction terminal is operating in self-serve mode;
store the received information in the entry for that transaction terminal to provide cumulative information covering both self-serve and assisted serve mode for that terminal; and
provide the transaction terminal with the cumulative information and/or individual transaction records for transactions carried out at the terminal.

Aptly, the server also provides the cumulative information to a separate management system.

Aptly, the received information relates to one or more transactions (such as transaction types, transaction amounts, account numbers, and the like), components within the transaction terminal (such as number of media picks by a pick unit, the number of prints by a print head, or the like), media remaining within the transaction terminal (such as banknotes within a currency cassette, paper within a printer, or the like), or the like.

Aptly, the server is operable to identify when the transaction terminal is switched between assisted serve mode and self-serve mode.

Aptly, the server stores secure data prohibited according to the Payment Application Data Security Standard (PA-DSS) for transactions executed at the terminal.

Aptly, the server stores the secure data under fault tolerant conditions.

According to a fifth aspect of the present invention there is provided a method of storing secure data, comprising the steps of:
when a transaction executing terminal is in a non-communicative state with respect to a primary authorizing node, storing secure data remotely from the terminal.

Aptly, the secure data is data associated with a media presented by a user to authorize the transaction at the terminal.

Aptly, the secure data is prohibited data according to the PA-DSS.

According to a sixth aspect of the present invention there is provided a server for communicating with a transaction terminal, where the server is operable to:
receive information from the transaction terminal that comprises secure data associated with a transaction executed at the terminal and which is not stored at the terminal;
store the received information in an entry for that transaction terminal in a data store accessible by the server; and
subsequently provide the secure data to the transaction terminal.

Aptly, the server receives the secure data from the transaction terminal when the transaction terminal is in a non-communicative state with a card issuer or card issuer gateway; and
the server provides the secure data to the transaction terminal when the transaction terminal returns to a communicative state with the card issuer or card issuer gateway.

Certain embodiments of the present invention provide data persistence facilities via the internet or other such network to store data associated with transactions. The remotely stored data can be referred to subsequently should an error occur locally at a terminal which would otherwise make reconciliation or transaction completion impossible.

Certain embodiments of the present invention store key data such as transaction critical data or other data associated with transactions carried out at a terminal under fault tolerant conditions. As a result, should an error occur or a power source be temporarily disconnected, the data persists until the error is cleared and this persisted data can be utilized to update lost or non-completed records.

By providing persistent storage in a cloud-based solution, ATM applications can maintain their data in a central location where rigorous fault tolerance procedures are put in place to ensure no data is lost.

Certain embodiments of the present invention use “cloud” based storage which can be used to ensure that transactions completed whilst an authorizing/recording network is offline can be buffered and then forwarded when communication with the authorizing network is restored. This can enable transactions to continue when certain authorizing nodes are offline and then allow transactions such as cash dispense or cash deposit transactions to be reported to a primary authorizing node when this comes back online.

Certain embodiments of the present invention provide a software interface for ATM applications to request data to be persisted, restored and deleted. By providing a central, albeit remote, depository for data which can be stored under fault tolerant conditions, multiple customers of a network do not have to individually provide fault tolerant storage for their key information.

### BRIEF DESCRIPTION OF DRAWINGS

Embodiments of the present invention will now be described hereinafter, by way of example only, with reference to the accompanying drawings in which:

FIG. 1 illustrates an Automated Teller Machine (ATM) according to an embodiment of the present invention;

FIG. 2 illustrates a cash management system able to remotely store transaction critical data under fault tolerant conditions;

FIG. 3 illustrates an alternative cash management system according to an embodiment of the present invention; and

FIG. 4 illustrates a still further cash management system according to an embodiment of the present invention.

### DESCRIPTION OF EMBODIMENTS

In the drawings like reference numerals refer to like parts.

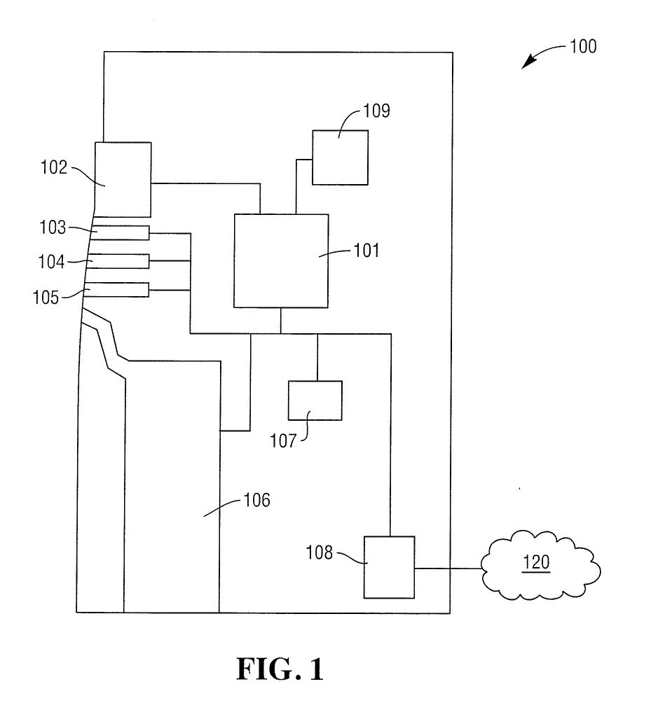

FIG. 1 illustrates a block diagram of a Self-Service Terminal (SST) 100 in the form of an Automated Teller Machine (ATM), according to an embodiment of the present invention. It will be understood that certain embodiments of the present invention are not restricted to such transaction executing terminals. Rather, certain embodiments of the present invention are broadly applicable to the operation of terminals able to execute transactions between the terminals and a third party such as a member of the public or member of an organization. Such terminals may thus be ATMs, vending machines, teller cash recyclers (TCRs), change machines, kiosks, fast lane POS or the like. In such a terminal items of media are dispensed from the terminal and/or deposited at the terminal. Such items of media have an inherent value and therefore the dispensation or deposit of such items via the terminal must be logged as transactions occur. In the ATM shown in FIG. 1, sheet-like items of media in the form of currency notes are moved from one location to another when they are dispensed or deposited. It will be understood that certain embodiments of the present invention are not restricted to the execution of transactions in which currency notes are deposited or dispensed. Likewise, items of media in the terminals may be currency notes, checks, tickets, gyros, vouchers, stamps or the like and the terminals may support only deposit transactions or only dispense transactions or deposit and dispense transactions.

The ATM 100 includes different modules for enabling transactions to be executed and recorded by the ATM 100. These ATM modules include customer transaction modules and service personnel modules. The ATM modules include an ATM controller 101, a customer display 102, a card reader/writer module 103, an encrypting keypad module 104, a receipt printer module 105, a cash dispenser/deposit module 106, a journal printer module 107 for creating a record of every transaction executed by the ATM, a connection module 108 and an operator panel module 109 for use by a service operator (such as a field engineer, a replenisher (of currency, of printer paper or the like), or the like).

Certain customer transaction modules (such as the ATM controller 101) are also used by the service personnel for implementing management functions. However, some of the modules are referred to herein as service personnel modules (such as the journal printer module 107 and the operator panel module 109) because they are never used by ATM customers. The ATM 100 is a node or network end point in an overall financial network. The ATM 100 is connected to the remainder of the financial network via a connection to the internet 120. It will be appreciated that the ATM 100 could alternatively be connected to the remainder of the financial network via an intranet or other public or private connection network.

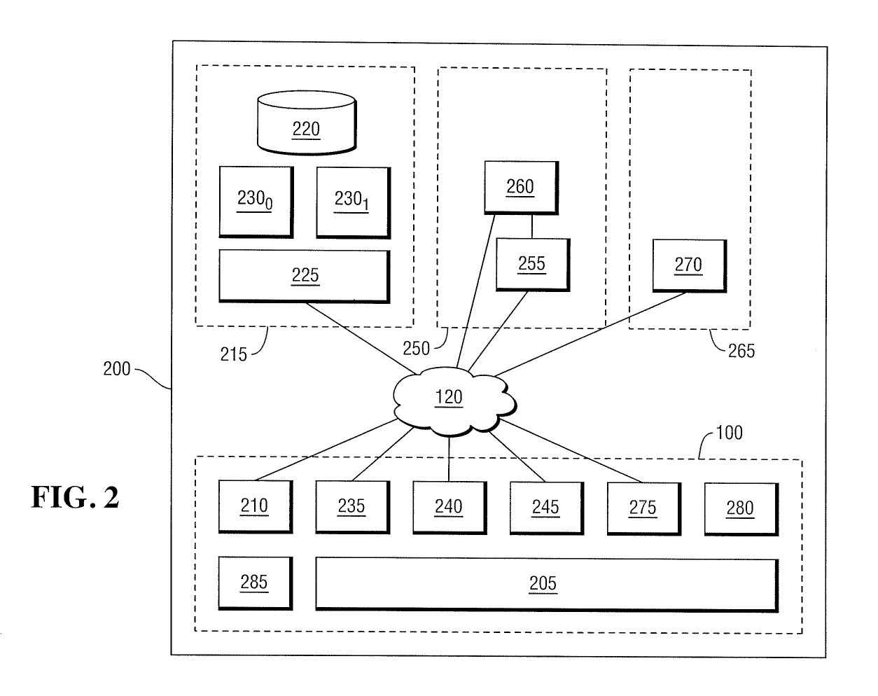

FIG. 2 illustrates a transaction execution system 200, according to an embodiment of the present invention. In particular, the transaction execution system 200 illustrated in FIG. 2 is a cash management system including multiple transaction executing terminals such as the ATM 100 shown in FIG. 1. As noted above, such a terminal could be a teller assist terminal, self-service kiosk or the like. The terminal includes a terminal application 205 which, when run, causes the terminal to operate in a desired manner. One or more terminal applications may of course co-exist within the same terminal. The terminal also includes an NVRAM interface 210. This provides an interface for software components within the ATM to store, retrieve and delete persistent data at a data persistence data center 215.

The data persistence data center 215 includes a fault tolerant storage medium 220 which is non-volatile random access memory or other data storage device able to persist data regardless of error or power down. The data center 215 includes a load balancer 225 that helps maximize system performance and availability. This balances the load between multiple servers (two shown 230₀, 230₁). Each server has read and/or write access to the fault tolerant storage medium 220. The servers provide additional capacity and/or duplication.

The ATM 100 also includes a transaction recorder interface 235 which provides an interface to record, retrieve and delete transactions at the data persistence data center 215. The ATM 100 also includes a transaction journal interface 240 which provides an interface to record, retrieve and delete journal records at the data persistence data center 215. The ATM 100 also includes a primary transaction authorization interface 245. This provides an interface to authorize transactions carried out under authorization of a primary transaction host 250. It will be understood that there may be more than one transaction host configured as a primary transaction node so there may be multiple instances of a primary transaction authorization interface 245 on the terminal. Each primary transaction host is associated with a respective one primary transaction interface. Optionally, all primary transaction hosts may share a single primary transaction interface.

The primary transaction host 250 is an example of a primary authorizing node. This represents a transaction authorization host that is deemed to be a primary system of record. As such, it must be informed of all transactions completed at the terminal to enable it to provide accurate transaction and cash reports. It will be appreciated that if more than one transaction host is considered as a primary authorizing node, then a primary authorizing node can also be considered as a further authorizing node. If more than one system must maintain a system of record, then transactions authorized on one primary transaction host must be reported to any remaining primary transaction hosts. The primary authorizing node 250 includes a primary transaction authorization host interface 255 which provides an interface for authorizing transactions managed by the primary transaction host/authorizing node. Any transaction authorized through the primary transaction host interface 255 will be reported to the system of record via a system of record interface 260.

FIG. 2 illustrates a further authorizing node in the form of an additional transaction authorization host 265. This is a transaction authorizing node that authorizes transactions it is responsible for but does not need to be aware of any other transactions completed at the terminal. Communication with the further authorizing node 265 is carried out via an additional transaction host interface 270. The ATM 100 includes a system of record interface 275 which provides an interface to allow transaction information for transactions authorized through an additional transaction host to be reported to the transaction authorization host that is maintaining the system of record. That is to say, the (or a designated) primary authorizing node. The ATM also includes an additional transaction interface 280 which provides an interface to further transaction authorization nodes. A respective additional transaction interface is provided on the terminal for each further authorizing node that a terminal communicates with. The terminal also includes an NVRAM application programming interface 285.

Certain embodiments of the present invention thus provide an ATM that communicates with two (or more) different transaction authorization nodes or hosts, i.e. transaction authorization node A and transaction authorization node B. It will be appreciated that the terminal may be able to communicate with two, three or more authorizing nodes. One or more of these authorizing nodes may be primary authorizing nodes in the sense that they need to be informed of all transactions that impact on the quantity of cash held within the ATM or some other such parameter associated with a terminal.

When a transaction is completed after being authorized by a further authorizing node (which thus acts as an additional transaction host 265), information associated with the transaction must be reported to the primary transaction authorizing node 250. In this sense, the primary authorizing node 250 acts as a primary authorizing host. This is achieved by reporting any transactions executed under authorization from a further authorization node to the primary authorizing nodes system of record interface 255 through the terminal system of record interface 275.

The availability of the multiple transaction authorizing nodes is completely independent. That is to say, it is possible to authorize and complete/execute transactions through authorization via the primary and/or further authorizing nodes when the other is unavailable and vice versa. This means that if a primary transaction node is unavailable in the sense that it is in a non-communicative state with respect to the terminal, then whilst it is not possible to update its system of record immediately when a transaction is completed, the transaction can nevertheless be authorized and carried out. When this situation arises reporting the transaction authorized by a further authorizing node to the primary authorizing node is deferred for later. This is achieved by saving the transaction details for later reporting when the primary authorizing node becomes available. To ensure that these transaction details are not susceptible to loss due to terminal events such as a hardware failure or system update, this data is stored under fault tolerant conditions on the terminal or, as indicated in FIG. 2, remotely via the internet in the data persistence data center 215. This helps maximize the robustness of the system and the remote services are used to persist, restore and delete transaction details. When the primary transaction authorization host system of record 260 is unavailable, then the terminal application will store the details of any transaction executed and as authorized by a further authorization node by using the transaction recorder interface 235. This interface communicates with the data persistence data center 215 to persist the transaction details using the IT infrastructure (load balancer 225, servers 230 and fault tolerant storage medium 220).

When the primary transaction authorizing node system of record 260 becomes available, the terminal application reports any deferred transaction by retrieving the details of a transaction from the data persistence data center 215, reporting the transaction to the primary transaction authorization node system of record 260 through the system of record interface 275. If the transaction is reported successfully, then the reported transaction details are deleted from the data persistence data center 215. This process continues until all transactions persisted at the data persistence data center 215 for that terminal have been successfully reported.

It will be appreciated that in the above-made comments, the differentiation between a primary transaction interface 255 and system of record interface 260 is a logical differentiation. The interfaces may be implemented as separate entities or may be implemented by the same software and/or hardware modules. This likewise applies to the primary transaction interface 245 and system of record interface 275.

Aptly, one or more of the transaction authorization nodes may maintain a system of record and some may not. For example, there may only be one transaction authorization host that maintains a system of record (i.e. one primary transaction authorization host) and one or more transaction authorization hosts that do not maintain a system of record across all ATM transactions (i.e. they only act as a further/additional transaction authorization host).

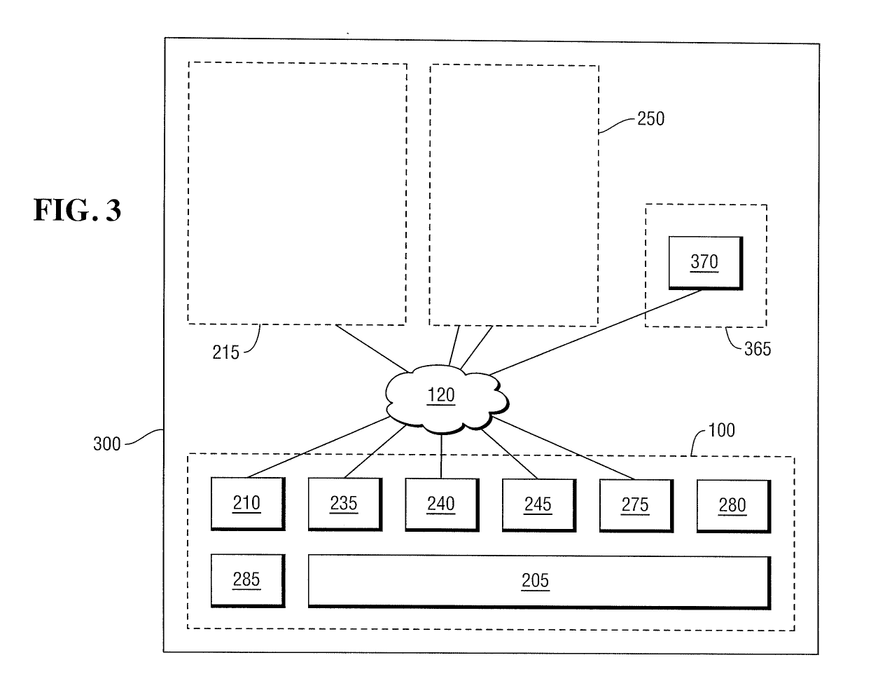

FIG. 3 illustrates an alternative embodiment of the present invention in which transaction data can be stored when a primary transaction authorizing host 250 is offline and the transaction at a terminal 100 is authorized via ATM business logic. The transaction execution system 300 illustrated in FIG. 3 shares many common features with that described with respect to FIG. 2, however, in the system shown in FIG. 3, a further authorizing node is provided by an EMV card reader device 365. EMV refers to Europay, Mastercard and Visa, which is a global standard for inter-operation of integrated circuit cards (IC cards or “chip” cards) and IC card capable point of sale (POS) terminals. This is a non-limiting example of a local authorization mechanism. The card reader device is optionally incorporated in the terminal itself or as illustrated may be a separate device. It will be appreciated that the host 365 illustrated in FIG. 3 can be used to authenticate customer transactions even if the primary transaction authorization host 250 is offline. Local business rules (such as pre-configured floor limits, transaction frequency, transaction magnitude or the like) allows cash dispense and media deposit transactions to be authorized from an ATM or for purchase transactions to be completed in the retail environment. In any of these scenarios the primary transaction authorization host 250 must be informed of these transactions when it becomes available again. If these transaction details are merely stored on storage media locally, then there is a single point of failure that could result in these transactions never being reported. Likewise, when data that is secure data prohibited according to the Payment Application Data Security Standard (PA-DSS) is exposed by the reader, such data must be stored only under pre-determined conditions. Such conditions may not be available at the terminal. To overcome this problem, the data persistence data center 215 is used to store data associated with a transaction carried out under authorization from the further authorizing node 365.

When a transaction is authorized and a primary authorizing node is offline, the data persistence data center 215 is utilized to persist key data via the transaction recorder interface 210. When the primary transaction authorization host 250 becomes available again, the terminal retrieves details of each transaction from the data persistence data center 20 and then updates the primary transaction authorization nodes system of record. Similarly, when a media is presented to authorize a transaction, magnetic stripe and/or CVV2 and/or PIN data or other such secure data is communicated to the persistence data center for secure storage under conditions that comply with the PA-DSS standard. Such data can later be used to inform a primary authorizing node about the transaction when the primary authorizing node, such as a card issuer or gateway to an issuer, comes back online.

Certain embodiments of the present invention can be utilized to replace NVRAM which would otherwise be needed on a local terminal. Rather than have the NVRAM locally on a terminal, the NVRAM interface 210 is utilized to store key data such as transaction critical data or the like within the data persistence data center 215. In some cases, locally provided NVRAM (provided at a terminal) is utilized to store transaction progress data locally to assist maintain system performance. This transaction progress data is data which changes rapidly and should be updated rapidly. Aptly, longer lived and/or rarely accessed data is stored remotely under fault tolerant conditions in the data persistence data center 215. This helps balance risk versus operational performance.

Aptly, certain embodiments of the present invention are used to maintain a central electronic transaction journal. As transactions are completed, they are recorded in the journal. Aptly, a paper journal record is optionally provided as a transaction journal in addition to an electronic journal. In the electronic journal transaction records are stored on local electronic media (such as a hard disk or the like). These electronic journals can be retrieved for examination or archive purposes by specialized software agents running on the ATM. The agents upload electronic journal data to a central application that then processes the content as required (to allow archiving or viewing or the like). The data persistence data center 215 is used to store the electronic journal data records, thus avoiding the risk of this data being lost before it is retrieved and also avoiding the need to have special processes for retrieving the electronic journal. In such embodiments, the application uses existing electronic journal APIs for recording the transaction details. This API uses the transaction journal interface 240 to store the data at the data persistence data center 215.

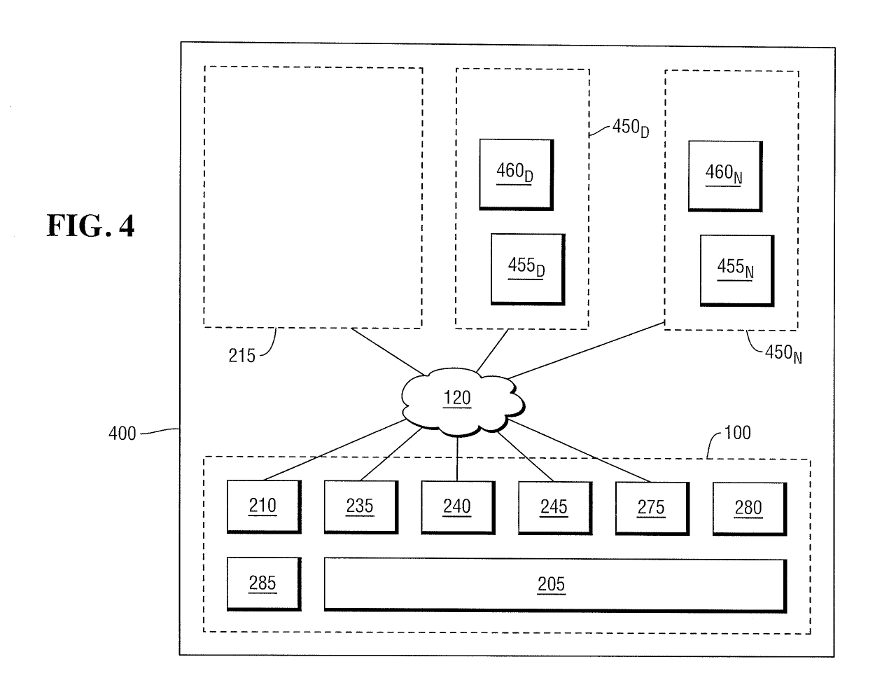

Certain embodiments of the present invention illustrated in FIG. 4 support a system that offers teller assisted transactions during one period of operation and self-service transactions during a remainder period of operation. When operating in teller assist mode, the system communicates via a branch network to a branch transaction authorization system. When operating in self-service mode, the system communicates with a self-service transaction authorization host. Because only one of these transaction authorization hosts is available at any one time (dependent upon a time of day or other such parameter), the remaining transaction authorization host is unaware of any transactions authorized and media dispensed/deposited by the active transaction authorization host. When the system is switched from one mode to another, any transactions and/or media dispense/deposits made while in the active mode must be reported to the transaction authorization host associated with the new mode of operation that is being activated. It will be appreciated that this is very similar to the embodiments previously described with respect to FIG. 2. A difference is that a primary authorization host is never online simultaneously with a further authorization node. Therefore, transactions authorized by one system cannot be reported to the other immediately after completion of the transaction. In such circumstances, transaction details of a type which must be reported for transactions authorized by an active transaction authorization host must be persisted for late reporting to the other transaction authorization host when it becomes active. Aptly, a level of detail that needs to be reported is configurable so that the system can report the details of every transaction or just aggregated dispense and deposit totals and/or other selected parameters.

As shown in FIG. 4, the cash management system 400 shares many common features with that described with respect to FIG. 1. Such features are not described again for the purposes of clarity. The system 400 illustrated in FIG. 4 shows a terminal 100 which receives authorization for transactions carried out at that terminal during a first period of time from a respective primary transaction authorization host 450. For example, this primary authorizing node is authorized to authorize the execution of transactions carried out at the terminal 100 between 9.00 am and 5.00 pm. As such, this is referred to as the daytime primary authorizing node 450_{D}. The daytime primary authorization host includes a daytime primary transaction host interface 455_{D} and a daytime system of record interface 460_{D}. These operate as per the primary transaction host 250 described with respect to FIG. 2 during the daytime.

The cash management system 400 illustrated in FIG. 4 also includes a further primary transaction authorizing node which is operational from 5.00 pm to 9.00 am during a 24-hour period. For this reason, the further primary transaction authorizing node is referred to as a night-time primary transaction authorizing node 450_{N}. This night-time primary authorizing node operates much like the primary authorizing node 250 illustrated and described with respect to FIG. 2. When the daytime mode is entered at the terminal, or some other mechanism is used to reconfigure the system, a check is carried out to assess if there are any updates that need to be communicated to the daytime primary transaction authorizing host 450_{D} as a result of activities completed under authorization from the night-time primary transaction authorizing host 450_{N}. Such updates may consist of updates to the cash and deposited media counts and/or can contain details of every transaction executed or other such transaction information. The daytime primary authorization host 450_{D} checks for details that need to be reported by checking the data persisted at the data persistence data center 215. If the system is configured to report every transaction executed by a remaining primary transaction authorizing host, then details are retrieved of the previous transactions executed through the transaction recorder interface 235. This information is then reported to the primary transaction authorizing node coming on line via its system of record through the system of record interface which is associated with that primary authorizing node. If the transaction is reported successfully, then transaction details are deleted from the data persistence data center 215 through the transaction recorder interface 235. This process continues until every transaction has been reported. If just media dispense/deposit details need to be reported, a similar process to retrieve, report and delete details is carried out.

Once all necessary details are reported during a mode change initialization, normal transactions can continue to be executed via the terminal 100 through authorization of the daytime primary transaction authorizing node. During this time, the night-time primary transaction authorizing node 450_{N} is not available. It is thus in a non-communicative state with respect to the terminal 100. This will thus need to be informed of the transaction details of transactions executed under authorization by the daytime primary transaction authorizing node when a mode of operation changes at around 5.00 pm and the night-time primary authorizing node becomes the online primary transaction authorizing node.

The Payment Application Data Security Standard (PA-DSS) is a security standard which determines how prohibited secure data must be stored relating to payment transactions. Part of the standard determines that it is impermissible to save user/card details without protection being put in place for that storage. Since it is difficult to save such data on a hard drive of a Self-Service Terminal or the like so that the PA-DSS requirements will be met, certain embodiments of the present invention provide a solution which has so far not been met. By saving the secure data on a secure server remote from an SST, data encryption and key management is allowed in such a way that card data can be saved in a secure manner an in a manner which satisfies the PA-DSS requirements. Aptly, secure encrypted storage is utilized to store such prohibited secure data.

In a similar manner, certain embodiments of the present invention allow for secure encrypted card details to be stored to allow for deferred reporting of AIT cash dispensed. Such information also needs a card's track data to be provided. Certain embodiments of the present invention enable track data to not be saved locally when a transaction is deferred but to retrieve these details from configuration when the transactions are replayed. This storage of card details remotely for configuration use complies with PA-DSS standards.

Certain embodiments of the present invention enable data which is useful and/or critical to be stored remotely from an operational terminal. The data is stored remotely in a manner that ensures that the data persists. That is to say, the data will not be lost under any circumstances. The persisted data can be used for power fail recovery and/or used to maintain dynamic configuration settings and/or used to allow an ATM to operate offline from a transaction authorizing system for a period of time etc. Persistence of data remotely from a terminal into some network storage facility helps ensure that the data cannot be lost.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

What is claimed is:

1. A method of storing data, comprising the steps of:
when a transaction executing terminal is in a non-communicative state with respect to a primary authorizing node, storing data associated with at least one transaction carried out at the terminal, and authorized by a further authorizing node, under fault tolerant conditions.

2. The method as claimed in claim 1, further comprising the steps of:
the terminal is an Automated Teller Machine (ATM) and said step of storing data comprises storing at least transaction critical data associated with at least one transaction carried out at the ATM.

3. The method as claimed in claim 2 wherein the step of storing said critical data comprises:
Subsequent, or substantially simultaneous with, to the completion of a transaction authorized by the further authorizing node at said ATM, providing the transaction critical data associated with said transaction via a network to a server node, remote from said ATM, comprising a secure storage medium; and
storing the critical data via the secure storage medium.

4. The method as claimed in claim 2 wherein the step of storing said critical data comprises:
during a transaction initiated between the ATM and the further authorizing node, repeatedly communicating critical data associated with the transaction via a network to a server node, remote from said ATM, comprising a secure storage medium; and
storing the critical data via the secure storage medium.

5. The method as claimed in claim 2, further comprising the steps of:
performing a plurality of transactions at the ATM whilst the ATM is in said non-communicative state; and
for each transaction storing associated transaction critical data under full tolerant conditions.

6. The method as claimed in claim 2, further comprising the steps of:
when the ATM returns to a communicative state with said primary authorizing node, communicating the stored critical data to the ATM; and
subsequently communicating the critical data or data associated with the critical data from the ATM to the primary authorizing node.

7. The method as claimed in claim 6, further comprising the steps of:
communicating the stored critical data to the ATM and communicating the critical data or the associated data from the ATM to the primary authorizing node transaction-by-transaction for each said transaction carried out at the ATM whilst the ATM was in the non-communicative state.

8. The method as claimed in claim 3 wherein the step of providing critical data via a network comprises providing the critical data via the internet.

9. The method as claimed in claim 2 wherein said step of providing critical data comprises providing data identifying a user ID and/or a currency amount associated with a dispense or deposit transaction and/or a transaction data and/or a transaction time and/or power fail recovery data.

10. A server for communicating with a transaction terminal switchable between a self-serve mode and an assisted serve mode, where the server is operable to:
receive information from the transaction terminal when the transaction terminal is operating in assisted serve mode;
store the received information in an entry for that transaction terminal in a data store accessible by the server;
receive information from the transaction terminal when the transaction terminal is operating in self-serve mode;
store the received information in the entry for that transaction terminal to provide cumulative information covering both self-serve and assisted serve mode for that terminal; and
provide the transaction terminal with the cumulative information and/or individual transaction records for transactions carried out at the terminal.

11. The server as claimed in claim 10 wherein the server also provides the cumulative information to a separate management system.

12. The server as claimed in claim 10 wherein the received information relates to one or more transactions (such as transaction types, transaction amounts, account numbers, and the like), components within the transaction terminal (such as number of media picks by a pick unit, the number of prints by a print head, or the like), media remaining within the transaction terminal (such as banknotes within a currency cassette, paper within a printer, or the like), or the like.

13. The server as claimed in claim 10 wherein the server is operable to identify when the transaction terminal is switched between assisted serve mode and self-serve mode.

14. The server as claimed in claim 10 wherein the server stores secure data prohibited according to the Payment Application Data Security Standard (PA-DSS) for transactions executed at the terminal and optionally the server stores the secure data under fault tolerant conditions.

15. A method of operating a transaction executing terminal comprising the steps of:
storing data associated with operation of the terminal under fault tolerant conditions remotely from the terminal.
